(19) United States
(12) Patent Application Publication
(10) Pub. No.: US 2002/0152185 A1
(43) Pub. Date: Oct. 17, 2002

(54) Method of network modeling and predictive event-correlation in a communication system by the use of contextual fuzzy cognitive maps

(75) Inventor: Nanjunda Swamy Satish Jamadagni, Bangalore (IN)

Correspondence Address: SCHWEGMAN, LUNDBERG, WOESSNER & KLUTH, P.A., P.O. BOX 2938, MINNEAPOLIS, MN, 55402, US

(73) Assignee: Sasken Communication Technologies Limited

(21) Appl. No.: 10/034,689

(22) Filed: Dec. 28, 2001

Related U.S. Application Data
(60) Provisional application No. 60/259,443, filed on Jan. 3, 2001.

(51) Int. Cl. G06F 15/18

(52) U.S. Cl. 706/1; 708/3

(57) ABSTRACT

The present invention provides an event-correlation technique that can infer from patterns of events to achieve improved problem analysis in communication networks. Further, the technique adapts itself to uncertainties and changes in communication networks to better serve the needs of communication networks. This is accomplished by forming fuzzy cognitive maps including causally equivalent fragments using the network element interdependencies derived from a database defining the network managed objects and event notifications that can convey the state of one or more managed objects. The technique further samples generated incoming real-time events from the communication network. The sampled events are then mapped to the fragments to diagnose problems.

### CROSS-REFERENCE TO RELATED APPLICATION

This application claims benefit under 35 U.S.C. 119(e) of U.S. Provisional Application Serial No. 60/259,443, filed Jan. 3, 2001, which is incorporated herein by reference in its entirety.

### FIELD OF THE INVENTION

This invention generally relates to managing networks, and more particularly to an event-correlation system for managing communication networks.

### BACKGROUND

Network management encompasses activities involving maintenance and proper control of resources and services in today's communication networks. Network management is needed to ensure that networks provide the services that are required of them. Network management can be explicit or implicit, centralized, partially centralized or distributed. In centralized management, a central management station called a ‘manager’ is operated by a network operator, and the management elements that reside on the network elements are called ‘agents’. In a distributed management system, the management functionality is spread across agents with no central management station. Implicit management involves control functionality at the protocol level in a network system. For example, many features such as flow controls, congestion control mechanisms, and error corrections are built into a communication protocol.

Managing present day communication networks have become more complex and the reliability of such networks has become dependent upon timely and successful detection and management of problems in the system. Problems can include faults, performance degradation, intrusion attempts, and other exceptional operation conditions requiring corrective actions. Problems generate observable events, and these events can be monitored, detected, reported, analyzed and acted upon by humans or by programs. An event is defined as an exceptional condition in the operation of the network. Events are often the result of underlying problems such as hardware or software failures, performance bottlenecks, configuration inconsistencies, or intrusion attempts. Since a single problem event in one resource may cause many symptom events in related resources, operational staff must be able to correlate the observed events to identify and localize underlying problems. Therefore, event-correlation is playing an important role in the management of such complex systems. Event-correlation is the interpretation of multiple events as a unit (the term event in this document is used interchangeably for network alarms or notifications).

Event-correlation is part of fault and performance management and is used to detect and isolate faults by correlating event streams from a communication system. A fault is a disorder occurring in the managed network, and can arise, for example, because of. hardware/software failures, performnance bottlenecks, configuration problems, security violations, etc. Fault management deals with the detection, isolation, and repair of problems in a communication system. Alarms or events are external manifestations of a fault (an event is seen as an exception condition in the operation of the communication system). Some important aspects of communication system management (or network management) include monitoring, handling, and interpreting events.

In a communication network, faults in a network segment can be conceived as crisp, but the degree of evidence that is available to a manager entity is generally fuzzy. In other words, there is no one message that indicates a fault; instead there are a collection of events in a time order that indicate fault or performance figures. In the network, state change from a healthy state to a faulty state is not sudden but gradual, with notifications indicating the change. Thus, fault or performance indicators can be seen as concepts that are indicated by a collection of network events.

Presently, event-correlation and fault isolation in communication systems are performed manually by a network operator. In a communication system, a single malfunction in one resource may cause firing of many events in related resources, leading to an event burst. Operators must be able to correlate the events to identify and localize the underlying problem in a communication system. This task is extremely difficult to handle manually. When looking for malfunctions in a communication system, the network operators decide which events to monitor and how to analyze them. Operators must also be familiar with the operational parameters of each component in a communication system and the significance of its events. As most problems cut across domains, operators from different domains must coordinate the analysis of their respective domains.

Networked systems often include thousands of managed objects (MOs) (the smallest manageable entity in a communication system). The detailed knowledge required to analyze events in an ever-growing collection of interacting, exceeds human capacity. During an event storm, there is an explosion of events and network operators must contend with this massive set of events. Also, operators must deal with the vagueness associated with knowledge of the domain. Automating event-correlation and fault isolation is recommended to overcome the problems discussed above.

One of the challenges in developing an automated event-correlation system lies in developing correlation between events. Event-correlation is achieved by capturing causal (cause-and-effect dependencies between events), temporal (dependencies specified with time) and topological (dependencies between events based on the network topology) dependencies.

An event-correlation algorithm attempts to reduce information redundancy in typical communication systems. It also helps reduce decision complexity, decision uncertainties, and helps handle difficulties arising from directly monitoring passive network components. For example, with respect to directly monitoring passive network components, cables are monitored for the arrival or non-arrival of events through the cables.

An automated event-correlation system generally has to provide for modeling of causal, temporal, and topological dependencies between events. Topological dependencies can sometimes be captured through temporal specifications.

Some current event-correlation schemes assume that a large set of training data (network log data) is available to ensure that the neural network functions smoothly. Network log data, however, might not always be available. Other event-correlation schemes do not take uncertainties in a network into consideration. This might fail if there are frequent configuration changes in a communication network. Also, some current event-correlation schemes use a causal graph to represent dependencies and generate a codebook of composite events. The detection process involves using a distance measure and a look-up process between an arrived sequence of events in an arbitrary time window and the encoded composite events in the codebook. A disadvantage with this approach can be that negative causal effects, as well as temporal constrains, and dependencies cannot be monitored. Also, in these approaches there can be no mechanism to handle uncertainties associated with a network model. Most other current event-correlation schemes try to specify a language to specify event dependencies. Such languages can suffer from being too rigid in the sense that uncertainties cannot be dealt with. Also, in language dependent event-correlation, the syntax of the language has to be learnt to code the dependencies.

In addition, today's systems change rapidly; it is not unusual for a system to undergo additions, removals, or upgrades to software or hardware components every day. Accurate networked system analysis requires up-to-date information about causal propagation across objects.

Thus, there is a need in the art for an event-correlation system that better addresses needs specific to communication networks. There is also a need for an event-correlation system that is robust and can adapt to changes in communication networks. There is also a need for an event-correlation system that can handle both centralized and distributed communication networks. Further, there is also a need for an event-correlation system that can handle uncertainties associated with the communication networks.

### SUMMARY OF THE INVENTION

The present invention provides an apparatus for an improved event-correlation system that achieves improved problem analysis in communication networks by analyzing patterns of events. Further, the system improves the problem analysis by adapting itself to uncertainties and dynamic changes in communication networks. In one example embodiment, this is accomplished by forming fuzzy cognitive map fragments using the network element interdependencies derived from a database defining the network managed objects and event notifications that convey the state of one or more managed objects. The system further requires sampling generated incoming real-time events from the communication network. The sampled events are then mapped to the FCM fragments to diagnose the problem.

Another aspect of the present invention is a for an improved event-correlation system that better serves the needs specific to communication networks. The method is performed by forming fuzzy cognitive map fragments using the network element interdependencies derived from a database defining the network managed objects and event notifications that convey the state of one or more managed objects. The method then requires sampling generated incoming real-time events from the communication network. The sampled events are then mapped to the FCM fragments to diagnose the problem.

Another aspect of the present invention is a computer readable medium having computer-executable instruction for an improved event-correlation system that better serves the needs specific to communication networks. According to the method, fuzzy cognitive map fragments are formed using the network element interdependencies derived from a database defining the network managed objects and event notifications that convey the state of one or more managed objects. The method then requires sampling generated incoming real-time events from the communication network. The sampled events are then mapped to the FCM fragments to diagnose the problem

Other aspects of the invention will be apparent on reading the following detailed description of the invention and viewing the drawings that form a part thereof.

### BRIEF DESCRIPTION OF THE DRAWINGS

FIG. 1 is an example embodiment of a block diagram of an event-correlation system including major components according to the present invention.

FIG. 2 graphically depicts one example embodiment of a quantifier set that may be stored within and used by the system shown in FIG. 1.

FIG. 3 depicts one example embodiment of the effect of an FCM node on another that may be stored within and used by the system shown in FIG. 1.

FIG. 4 illustrates one example embodiment of an FCM that models network dependencies that may be stored within and used by the system shown in FIG. 1.

FIG. 5 illustrates one example embodiment of an FCM fragment that shows an intermediate concept node that may be stored within and used by the system shown in FIG. 1.

FIG. 6 illustrates one example embodiment of an FCM that models temporal dependencies that may be stored within and used by the system shown in FIG. 1.

FIG. 7 illustrates one example embodiment of a multi-path possibility within an FCM that may be stored within and used by the system shown in FIG. 1.

FIG. 8 illustrates one example embodiment of a local area network in which an FCM event-correlation system may be implemented and depicts a manager console in which the FCM event-correlation system may be stored and used.

FIG. 9 illustrates an example embodiment of network events flowing into a manager console of the network shown in FIG. 8 in a central managed communication system.

FIG. 10 illustrates one example embodiment of fuzzy sets that describe a link partial order that may be stored within and used by the manager consoles of network shown in FIGS. 8 and 9.

FIG. 11 illustrates an example embodiment of an FCM fragment with linguistic variables and the same exemplary fragment with numerical values assigned to it that may be stored within and used by the manager consoles shown in FIGS. 8 and 9.

FIG. 12 illustrates graphically one example embodiment of numerical values that may be assigned to a linguistic variable through the spread of evidence.

FIG. 13 illustrates one example embodiment of fuzzy sets for concept node activation levels that may be stored within and used by the manger console shown in FIGS. 8 and 9.

FIG. 14 illustrates one example embodiment of an FCM fragment for the network shown in FIG. 8 that may be stored within and used by the manager consoles of FIGS. 8 and 9.

FIG. 15 is a flowchart illustrating the overall operation of the embodiment shown in FIG. 1.

FIG. 16 is a block diagram of a suitable computing system environment for implementing embodiments of the present invention, such as those shown in FIGS. 1 and 15.

### DETAILED DESCRIPTION

The present invention provides an improved event-correlation system that better serves the needs of managing dynamically changing managed objects in communication networks.

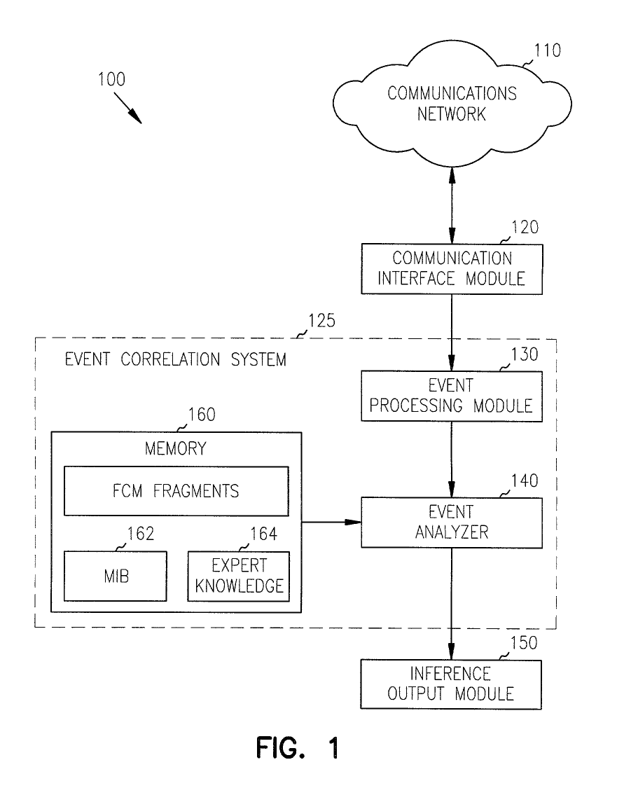

FIG. 1 shows a block diagram of an event-correlation system, including major components according to an embodiment of the present invention. The system 100 shown in FIG. 1, is connected to a communication network 110 connected to a communication interface module 120, which is further connected to an event-correlation system 125. The system 100 shown in FIG. 1 is further connected to an inference output module 150. In this example embodiment, the event-correlation system 125 further includes a processing module 130 that is connected to an event-analyzer 140. Event-analyzer 140 is further connected to a memory 160. In the embodiment shown in FIG. 1, memory 160 can include data such as management information base (MIB) 162, an expert knowledge base 164, and derived FCM fragments 166. The communication network 110 can be an explicit system, implicit system, centralized system, partially centralized system, and/or distributed system.

Event-analyzer 140 forms fuzzy cognitive map (FCM) fragments with network element interdependencies. FCM fragments are derived from a database defining the network managed objects and event notifications that convey the state of one or more managed objects. In some embodiments, event-analyzer 140 forms FCM fragments by determining event nodes from events in the database. Event-analyzer 140 further identifies concept nodes from the determined event nodes to form the FCM fragments including interdependencies between the identified concept nodes and the determined event nodes. In some embodiments, event-analyzer 140 forms FCM fragments by capturing system event interdependencies. Event-analyzer 140 captures system interdependencies by interconnecting event and concept nodes using interdependency arcs to capture temporal and logical dependencies. Event-analyzer 140 can also determined event nodes using expert knowledge of the communication network 110. Managed objects 162 can include objects such as network objects, attached systems, and/or application objects.

In some embodiments, event-analyzer 140 evaluates the indirect effect of events on concept nodes using the equations:

Iₚₓ(Eᵢ, Cᵢ)=min(eₚₓ(Eᵢ, Cⱼ))=min(eₚₓ_{ᵣ₁}((Eᵢ, Eₖ))⊕ . . . ⊕ min(eₚₓ_{ᵣₙ}(Eₖₙ, Cⱼ))

wherein the indirect effect of events E₁ on concept nodes Cᵢ can be defined as the intersection of the linked causal types and can be described by the above equation, eₚₓ is a function which takes Iᵢⱼ to [0, 1] in path ‘p’ i.e. e_{Iij}=f→(Iᵢⱼ, μᵢⱼ), μᵢⱼε{0, 1}, and ⊕ represents concatenation of paths, wherein the concatenation operator ⊕ is generally considered as a fuzzy ‘and’ operator, wherein the operator (t-norm) for the intersection of two fuzzy sets, other than ‘min,’ can be used using a ‘bounded difference,’ wherein the bounded difference can be computed using the equation:

t₁(μ_{A}(x), μ_{B}(x))=max{0, μ_{A}(x)+μ_{B}(x)−1}

wherein t₁( ) is a t-norm between fuzzy sets A and B with membership functions μ_{A} and μ_{B}. The indirect effect of events means predictive event-correlation.

Events can be exceptional conditions occurring during the operation of network 110. Event nodes can be significant events such as hardware/software failures, performance bottlenecks, configuration problems, and/or security violations.

Concept nodes are a composite set of events that capture a notion of an abstract exception condition in the network 110. Abstract exception condition can be conditions such as fault and performance degradation of the network 110. In some embodiments, event-analyzer 140 captures the abstract exception condition based on predetermined criteria to diagnose events. The predetermined criteria can be based on causal and/or temporal dependencies between events.

The database can be static information associated with each class of managed objects and/or dynamic information that affects the causal propagation of events. Static information can be obtained from operation manuals of attached systems, network objects, and/or application objects of network 110.

In operation, event-processing module 130 samples generated incoming real-time events from the network 110. Event-processing module 130 receives real-time events from the communication interface module 120. Communication interface module 120 receives real-time events in the form of simple network management protocol (SNMP), Common management information protocol (CMIP), and/or any other proprietary message. Communication interface module 120 extracts relevant information from messages received in various formats and inputs the information into the event-analyzer. The event-processing module samples incoming real-time events sequentially in the order they are received.

Event-analyzer 140 then diagnoses the problems from the sampled real-time events by mapping the sampled events to the formed FCM fragments. In some embodiments, event-analyzer 140 diagnoses problems by mapping the sampled events to the formed FCM fragments including determined event nodes to evaluate the effect of the mapped events on the determined concept nodes using the determined interdependencies. Then, the event-analyzer 140 identifies problems by analyzing the concept nodes based on the outcome of the evaluation and diagnoses the problems based on the outcome of the analysis.

In some embodiments, event-analyzer 140 maps the received real-time events to the formed FCM fragments by correlating the received events to the identified concept nodes to evaluate the effect of the received event nodes on the identified concept nodes using the determined element interdependencies. In some embodiments, event-analyzer 140 correlates the received events by accumulating evidence based on the received event nodes and compares the accumulated evidence to a threshold value. Event-analyzer 140 then analyzes the concept nodes based on the outcome of the comparing to evaluate the effect of the received event nodes. Interface output module 150 outputs solutions based on the outcome of the diagnosis by event-analyzer 140.

System 100 stores the static and dynamic information in the memory 160. Information in memory 160 can include Management Information Base (MIB), FCM fragments, and/or expert knowledge derived from operations manuals of the attached systems in the network 110. The MIB can be used to define a large number of managed objects as well as event notifications, which may convey the state of one or more managed objects. Event-analyzer 140 uses the MIB to capture dependencies between events belonging to different network classes or groups.

Network 110 can also include a collection of network objects, which is referred to as a manifold. The network objects can be associated through some logical or physical grouping such as access nodes, switching nodes etc. Resolutions are part of manifolds that enclose a set of objects defined by a network context, like performance-related messages generated due to a transport control protocol (TCP), the Internet protocol (IP), and/or the Internet control message protocol (ICMP) of the TCP/IP suite of protocols. A network can also have different contexts. A communication network such as the one shown in FIG. 1 can include elements such as network elements, its attributes, topology and manifolds.

Generally, current network modeling schemes captures the dependencies between different entities in a network so that causal dependency between network events and concepts are captured. In communication network, there are primitive events, notifications (raw events from a network), and/or concepts (composite events) that describe a set of events or notifications from the network. In communication networks, no one single message indicates a fault or performance degradation, but instead several events spanning a time period indicate the fault or degradation. Although the notion of fault or performance factors in communication networks is crisp, the degree of evidence generally available to a network manager to determine the fault or performance degradation is fuzzy.

FCMs may be used for network modeling. An FCM is a singed directed graph, where nodes represent events and edges represent the partial causal flow between nodes. The node in an FCM in a communication network context typically represents an elementary event (state of a managed object) or a network concept such as performance degradation. The edge can indicate positive or negative causal influence. A positive edge can imply that the occurrence of one event can cause the occurrence of another event (P can imply Q), while a negative edge can imply that the occurrence of one event can nullify the effect of the other event in the communication system (P can nullify Q). An FCM state may be represented as a vector at any given time.

FCM generally converges or settles to a fixed point or a limit cycle. A fixed point or limit cycle is generally the answer to a causal what if question such as, “What if event E(1) happens?” Generally, an FCM stores a set of rules in the form. “If E(1), then sequence A.” The fixed point or limit cycle gives deductive closure, i.e., all related events are covered in this closure by the initial assertion of a node (event). Methods of clustering a sequence of related events involve traversing through state vectors, where a subsequent state can be defined by the equation:

Cₙ₊₁=T(CₙE),

wherein ‘T’ is the threshold function, ‘C’ is a state vector and ‘E’ is the graph adjacency matrix.

FCMs help determine the effect of an event on another event. Basic definitions used in modeling network event dependencies, pursuant to one method that incorporates aspects of the invention, are described in detail in the following sections:

Key vertices: A vertex is called a key vertex if:

1. It is a common vertex of an input path or a circle (a circle is a path covering vertices {v₁, v₂, . . . vᵣ} and an arc from vᵣ to v₁); or

2. It is a common vertex of two circles with at least two arcs pointing to it, which belong to the two circles;

3. It is any vertex on a circle if the circle contains no other key vertices;

Tail node: a node without in-arcs;

Head node: a node without out-arcs;

Normal Path: A path P(v₁, v₂, . . . vᵣ) is called a normal path if v₁(1<i<r) has only one input;

Input Path: A path P(v₁, v₂, . . . vᵣ) is called an input path if:

1. ν₁ has no input or if it has only an external input sequence V₁, it is called an input vertex, or

2. νᵢ(1<i<r) does not belong to any circle

Raw events or network notifications: The state of a managed object (represented as E_{I}) is represented by raw events. Typically, the structure of a raw event consists of a time stamp, the event type, event subtype, equipment ID, severity of the event, description, etc.

Time Stamp
Event Type
Event Subtype
Equipment ID
Severity/Status
Description

The nodes and paths defined above are identified during the modeling phase and later used while defining the inference technique. In a communication network, a tail node is interpreted as an event that starts an event avalanche and head nodes are interpreted as usually representing concepts, such as major fault.

Composite Events (CE) are defined to capture the essence of the events or concepts over an FCM path connecting a tail node to a head node. Concept nodes in an FCM are composite events that capture the essence of the preceding few events (or nodes) in the FCM. Faults and performance grades can be seen as concepts because fault and performance definitions are not crisp in communication networks. A concept is defined as a node that captures the essence of a set of events from a network.

The following paragraphs only depict examples of methods for modeling and inferring in an FCM to achieve event-correlation. The examples depicted are not to be used to limit the invention. Other variables, equations and methods not depicted may be used to model an FCM for event-correlation and still fall within the scope of the invention.

For example, Cᵢ can define the partial order of concepts in the network. In particular, Cᵢεψ, where ψ defines the set of all network concepts, where Cᵢε{good(PERFORMANCE), not_so_good(PERFORMANCE), bad(PERFORMANCE)}, and where Cⱼε{minor(FAULT), major(FAULT), critical(FAULT)}.

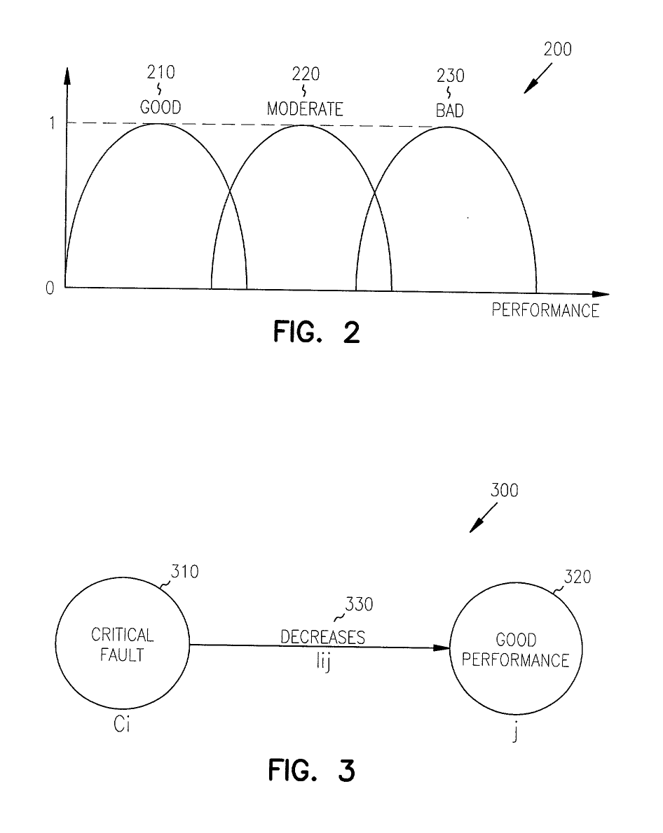

Cᵢ can also be decomposed into a quantifier (Qᵢ) set and a modifier (Mᵢ) set. From the above example, QᵢεQₐ={good, not_so_good, bad}, and Mᵢ={PERFORMANCE, FAULT} where Qₐ defines the partial ordering of quantifiers for each QᵢεQₐ. The causal abstract negation of Qᵢ is defined as ˜Qᵢ, and Q_{I} and ˜Q_{I} are symmetrical quantifiers. A median quantifier value is also defined. An example of a quantifier set 200 that can be used in event-correlation is shown in FIG. 2. In the example, ‘Bad’ 210 is the abstract negation of ‘Good’ 220 and ‘moderate’ 230 is the median quantifier.

A collection of events and concepts define an FCM space. In the example, Cᵢ=Q₁∪˜Q₁ can be used where ‘∪’ defines union or disjunction between fuzzy concepts. In the example, each causal link pair can be associated with each concept pair (Cᵢ, Cⱼ). The causal link pair may be depicted as, (Iᵢⱼ, ˜Iᵢⱼ):Ci→^{Iij}Cj, where Iᵢⱼ refers to the evidence or the degree of causality (or causal link type such as ‘near’ or ‘far’) by which Ci maps to Cj, and → refers to a fuzzy logical implication. Iᵢⱼ ↓ indicates causal decrease and Iᵢⱼ ↑ indicates causal increase; Iᵢⱼ can be discrete or an element belonging to a set of ordered causal links and relationships. One definition for Iᵢⱼ can be, Iᵢⱼ={INCREASED, NO_CHANGE, DECREASED}. The above definitions can be used to build FCM fragments, an example of building FCM fragments 300 is shown in FIG. 3. Further FIG. 3 illustrates, the effect of FCM nodes 310 on the other FCM node 320.

When modeling a communication system using FCMs causally equivalent fragments can be considered. In the example shown in FIG. 3, “DECREASES” 330 can be replaced by “INCREASES” but the quantifier of Cⱼ must also be replaced by “Bad.” Causally equivalent fragments give different interpretations of the same FCM.

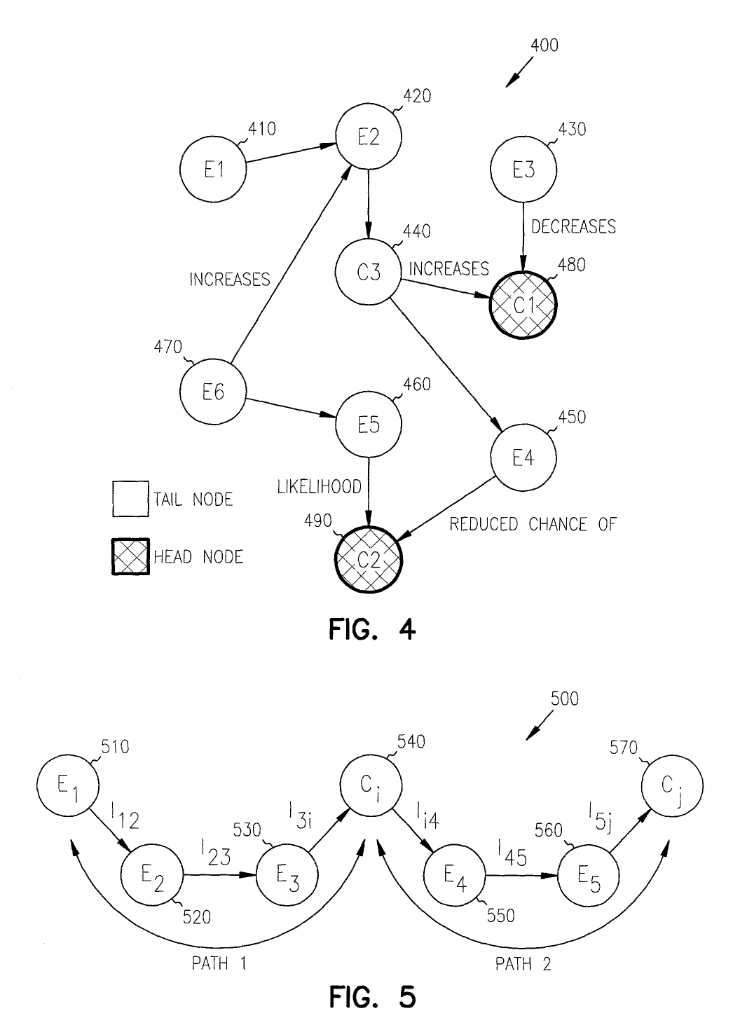

FIG. 4 shows a sample FCM modeling network 400 dependencies including event nodes 410-470 and concept nodes 480-490. Composite events (or concept events) are generally the head nodes in an FCM, but they can also indicate concept nodes in an FCM path. Such intermediate concept nodes indicate less severe fault or performance conditions.

FIG. 5 shows FCM fragment 500 including a node Cᵢ 540, which represents an intermediate concept node and Cⱼ 570 represents a head node (concept node). A concept node captures the gross information from the preceding nodes, usually from nodes such as tail nodes 510-530, and 550-560 shown in FIG. 5.

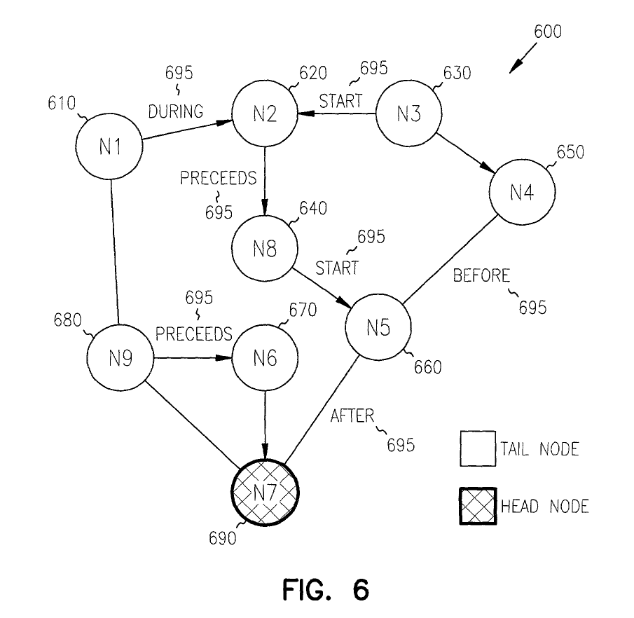

In the above examples, the definition of a causal link has been expanded to accommodate temporal dependencies between events or concepts. A subset of Allen's interval algebra (James F. Allen, Maintaining knowledge about temporal intervals, Communications of the ACM, 26(11): 832-843, 1983), can be used to specify the temporal dependencies between nodes in the FCM model of a communication network. This can help capture temporal dependencies that are essential in analyzing most communication systems. A small subset of the relations for example are, Iᵢⱼ={follow, after, during, start, before, precede}. FIG. 6 shows a sample FCM 600 capturing temporal dependencies 695 between nodes 610-690.

Event-correlation and Inferring Composite Event Triggers

One goal of event-correlation is to send the least number of events to the manager console as possible after having abstracted the network condition from a given set of network messages. Incoming network events or notifications can be applied on the available network model and captured as FCMs as described above.

Composite event detection (the effect of tail nodes on concept nodes, which in most cases are head nodes) can be achieved through, FCM interrogation. The notion of indirect and total effect (described in the following sections) of event nodes and concepts nodes in an FCM are used to detect the triggering of a composite or concept node.

One approach includes a composite event-triggering mechanism that addresses instances in a communication system when an alarm state persists for a short period of time and subsequently reverts back to a normal state. Direct computation of indirect and total effects to predict correlated event triggering might lead to the generation of spurious alarms. Pursuant to one, temporal mappings and node activation calculation are used to overcome this problem. This helps in checking for spurious alarm or performance degradation messages being sent to the manager.

Examples of indirect and total effects of event or concept on another event or concept node are given below.

The indirect effect of events Eᵢ on concept nodes C₁ can be defined as the intersection of linked causal types and can be described by an equation, such as equation (1) for example.

Iₚₓ(Eᵢ, Cᵢ)=min(eₚₓ(E₁, Cⱼ))=min(eₚₓ_{ᵣ₁}(Eᵢ, Eₖ))⊕ . . . ⊕ min(eₚₓ_{ᵣₙ}(Eₖₙ, Cⱼ)) (1)

P={P₁, . . . Pₛ} depicts over all one causal path and R={r₁, r₂ . . . rₙ} depicts all context levels; eₚₓ is a function which takes Iᵢⱼ to [0, 1] in path ‘p’ i.e. e_{Iij}=f→(Iᵢⱼ, μᵢⱼ), μᵢⱼε {0, 1 }, and ⊕ represents concatenation of paths. The concatenation operator ⊕ is generally considered as a fuzzy ‘and’ operator. In equation (1), any operator (t-norm) for the intersection of two fuzzy sets other than ‘min’ can be used, such as, for example, the ‘bounded difference’ defined in Zimmerman, H. -J. [1987], Fuzzy sets, Decision Making and expert systems, Boston, Dordrecht, Lancaster and given as in equation (2). The bounded difference operator

t₁(μ_{A}(x), μ_{B}(x))=max{0, μ_{A}(x)+μ_{B}(x)−1} (2)

The total effect of Eᵢ on Cᵢ is defined as the union of the linked causal types and is given below as equation 3.

T(Eᵢ, Cᵢ)=max(Iₚ(Eᵢ, Cᵢ)) (3)

The max operator in equation 3 can also be replaced by the ‘bounded sum’ (or any other appropriate t-conorm) operator which is given as below (equation 4)

S₁(μ_{A}(x), μ_{B}(x))=min{1, μ_{A}(x)+μ_{B}(x)} (4)

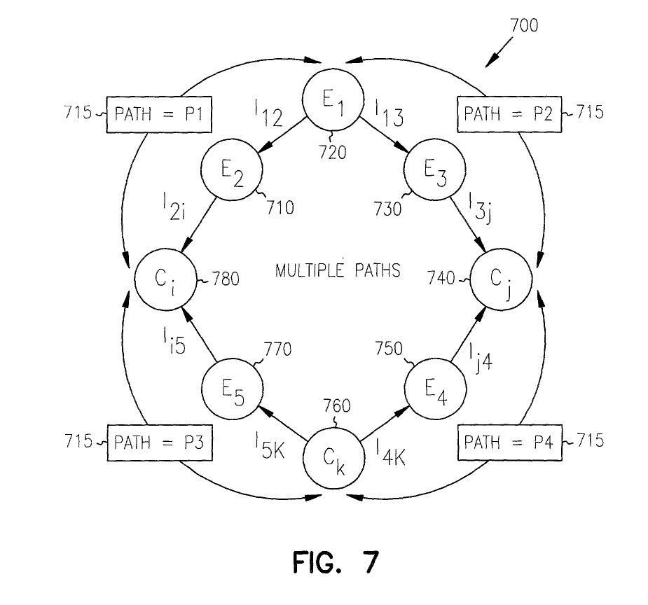

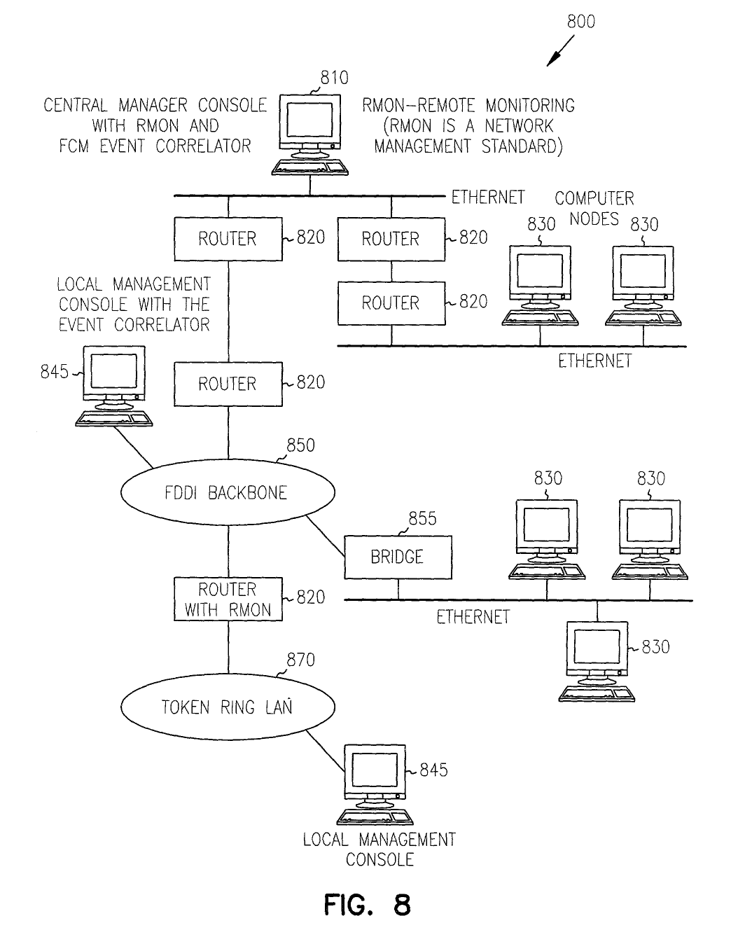

Pursuant to one method, if the indirect or total effect of a node on a concept node is “HIGH” or “MORE,” then that composite event is conceived as triggered and forwarded to the manager console. Multiple paths might exist between the event and the concept of interest. FIG. 7 shows one example of a multi-path possibility 700 in which indirect and total causal effects 715 on event nodes 710-780 have to be considered.

I_{(p1, p2, p3, p4)}={min(eₚ₁(E₁, Cᵢ))⊕ min(eₚ₃(Cᵢ, Cₖ))}Ψ{min(eₚ₂(E₁, Cj))⊕ min(eₚ₄(Cⱼ, Cₖ))} (5)

Equation (5) pertains to FIG. 7. The Ψ operator can be the multi-path operator and is usually considered as the fuzzy ‘or’ operator.

Pursuant to another method, a partial order of fuzzy sets can be used to achieve network dependency modeling. The partial order of effects between nodes used depends on the communication network context, a sample of which is provided.

Iᵢⱼ={VERY LITTLE, LITTLE, LESS, MODERATE, MORE, LARGE, VERY LARGE}.

Numerical ranges can be assigned to the above-mentioned linguistic variables and can depend on the specific communication network domain to which the event-correlation process is being applied (discussed in the example below). The numerical ranges can be obtained through experimentation and/or through querying experts.

Temporal inconsistencies between events and concept nodes in an FCM fragment, can be used to maintain the temporal orderings of the composite events as well as to predict when a composite event might occur in time. Temporal inconsistencies can also be used to calculate confidence levels of the evidence flow projections into a concept node. Temporal inconsistencies give the wait time to confirm that a follow up event (node) did occur in the network. Temporal projections are achieved by the use of a suitable composition operator.

Pursuant to one method, the definitions of head and tail nodes, key vertices, paths and a notion of confidence over time (temporal inconsistencies) can be used to infer composite events. A software data structure such as an association table (matrix) can be used to tabulate connections between tail nodes.

FCMs can be used to achieve event-correlation in communication networks as well as to achieve root cause analysis. Root cause analysis can be achieved in a hierarchical sense by using the network context and resolution. It has been observed that root cause analysis is required only for a small set of critical network conditions.

Those skilled in the art will recognize that the attributes of the methods described above may be used in conjunction with each other. For example, a method may use any combination of (dictated by a good understanding of the network for which the method is being applied) partial order of concepts, the computation of indirect and total effect of event and concept nodes, definition of partial order of fuzzy sets, computation of temporal confidence, definition of partial orders to capture temporal dependencies, data structure to capture the link states when used to model network dependencies and/or infer concepts through the use of FCMs.

In a communication network, the manager entity receives notifications as traps (either SNMP or CMIP). The manager can also query the network using programming interfaces. Some times the available evidence may be insufficient to inferring the triggering of a composite event. A method of querying for additional evidence [if some nodes are not contributing evidence] can be performed before determining composite event triggers. The manager entity can decide when to query and what information to query about the network status. For example, if the evidence flow into a concept node is just less than “LARGE” (i.e. if the evidence is “MODERATE” to “MORE”) and the concept nodes illustrates a critical network condition, then the status of the non-contributing nodes can be queried.

The methods described above may be used in a typical Local Area Network (LAN) 800, such as, for example, the one depicted in FIG. 8. It should be noted, however, that the system depicted in FIG. 8 is but one of a variety of systems with which the methods described above may be used. In the network 800 depicted in FIG. 8, the event-correlation system would typically be stored on a central manager console 810. Central manager console 810 would typically be configured to store FCMs, MIB files and process events in the same manner as the management system as depicted in FIG. 1.

A communication protocol includes several functionalities described in layers and is generally referred to as a protocol stack. (Refer to Network and Distributed Systems Management, Morris Sloman, Addison-Wesley publishing company, 1994). Different layers of the protocol stack can be implemented in different hardware and/or software units, as shown in FIG. 8. LAN 800 illustrates the central manager console 810 connected to the computer nodes 830 through routers 820, FDDI backbone 850, token ring LAN 870, Bridge 855, and local management consoles 845. For example, the computer nodes 830 in FIG. 8 generally implement the application layers and the transport layer functionality. The routers 820 typically implement the Internet Protocol (IP) functionality etc.

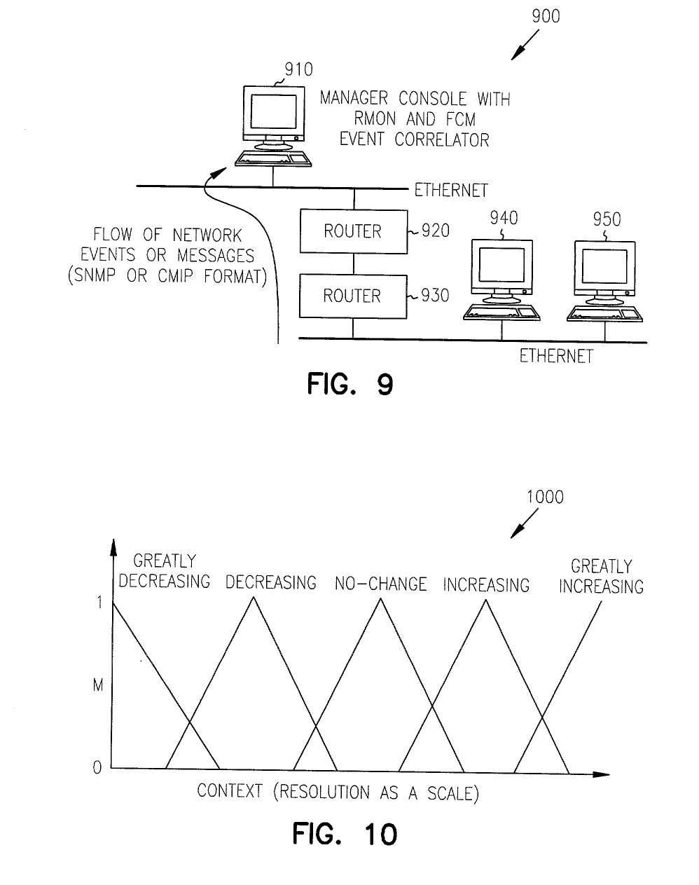

FIG. 9 illustrates the general flow of network events in a communication system 900. The network events of FIG. 9 carry the status of different components within the communication system 900. The protocol used to carry these network events can be for example, SNMP or CMIP or any other implementations. Manager console 910 is typically a high performnance computing system (For example, a SUN workstation) with high-end processing and memory capabilities and is typically configured in the same manner as the management system of FIG. 1.

Network elements can be elements like ‘router’ 920, ‘bridge’ 930, and other such elements that implement parts of a protocol stack, either in software or hardware. The event-correlation system, which is usually a software implementation, typically resides on the central manager console 910. Other implementations can be achieved with parts of the event-correlation system residing on local management consoles, such as the ones shown in FIG. 8. Parts of the event-correlation system can also be distributed to reside on key network elements.

In exemplary local area network system 900, messages received at the management station or the local management console contain the state of the managed objects that are listed in a Management Information Base (MIB). In this example, the FCM for achieving event-correlation is defined over the managed objects listed in the MIB. The specific SNMP or CMIP messages that are received gives the instantaneous values of the managed objects.

A sample MIB managed object definition example is listed below from the IP (Internet Protocol) group in MIB-II (which is a standard describing the layers and events in a protocol stack):

Object-ipInDiscards
Syntax-Counter
Access-RO (Read Only)

Description—Number of input IP datagrams discarded due to lack of buffer space.

In general, SNMP trap messages only carry the state of a small subset of the total number of objects in a communication system. The rest are generally consciously queried depending on the logic involved at the manager console. In this example, a small subset of managed objects is selected from the following groups:

1. IP group
2. Interface group
3. Ethernet group
4. ICMP group
5. Transmission group

The formation of FCMs for event-correlation involves using objects (to know their states) from different layers of a communication protocol. FCMs are defined over these managed objects and, in this example, managed objects from the groups mentioned above are considered. These groups cover the lower 3 layers of a typical ISO-OSI 7 layer communication protocol stack model (Refer to Network and Distributed Systems Management, Morris Sloman, Addison-Wesley publishing company, 1994). Those skilled in the art will recognize that other managed objects in other layers may also be considered.

The IP group contains basic counters of traffic flow into and out of the IP layer. In this example, the following objects are considered:

ipInDiscards-Number of input IP datagrams discarded due to lack of
buffer space.
ipOutDiscards-Number of output IP datagrams discarded due to lack of
buffer space.
ipOutNoRoutes-number of IP packets discarded because no route could be
found.
ipReAsmFails-Number of failures detected by the IP reassemble
algorithms.

Objects in the interface group are used to detect congestion as measured by the number of octets into or out of the system, or the queue length for output. Once congestion has been detected, other group objects can be examined to find out, for example, if protocol activity at the TCP or IP level might be responsible for the congestion. In this example, the following interface object states are of interest:

ifSpeed—An estimate of the interface's current data rate capacity.

ifAdminStatus—Desired interface state—Up(1), Down(2), Testing(3).

ifOperStatus—Current operational interface state—Up(1), Down(2), Testing(3).

ifInOctets—Total number of octets received at an interface including the framing characters.

ifInDiscards—Number of inbound packets discarded even though no errors have been detected to prevent their being delivered to a higher layer protocol (Buffer overflows).

ifInErrors—Number of inbound packets in error preventing them from being deliverable to a higher-layer protocol.

ifOutDiscards—Number of outbound packets discarded even though no errors have been detected to prevent their being delivered to a higher layer protocol (Buffer overflows).

ifOutErrors—Number of outbound packets that could not be transmitted due to errors.

IfOutQLen—Length of output packet queue length.

Systems that implement IP typically provide ICMP as well. ICMP provides feedback about problems in a communication system. Examples of its use include when a datagram cannot reach its destination, when a router does not have the buffering capacity to forward a datagram and when a router can direct a host to send traffic on a shorter route. In this example, the following are ICMP group objects whose states are of interest:

IcmpInDestUnreaches—Number of icmp destination unreachable messages received

IcmpInTimeExcds—Number of icmp time exceeded messages received

IcmpInParmProbs—Number of icmp parameter problem messages received

IcmpInSrcQuenchs—Number of icmp source quench messages received

IcmpInRedirects—Number of icmp redirect messages received

icmpOutDestUnreaches—Number of icmp destination unreachable messages sent

icmpOutTimeExcds—Number of icmp time exceeded messages sent

icmpOutParmProbs—Number of icmp parameter problem messages sent

icmpOutSrcQuenchs—Number of icmp source quench messages sent

icmpOutRedirects—Number of icmp redirect messages sent

icmpOutEchos—Number of icmp echo messages sent

icmpOutEchoReps—Number of icmp echo reply messages sent

The external gateway protocol (egp) group contains information about neighboring gateways known to an entity. In this example, the following objects are of interest:

egpNeighState—Idle(1), acquesition, down, up, cease.

egpNeighInErrs—Number of egp messages received from this egp peer with an error.

egpNeighInErrMsgs—Number of egp-defined error messages received from this egp peer.

egpNeighOutErrMsgs—Number of egp-defined error messages sent to this egp peer.

In this example, only the Ethernet interface MIB objects defined in the Ethernet interface MIB are considered for the transmission group. This also covers CSMA/CD operations. The following objects are of interest in this example:

dot3StatsAlignmentErrors—received frames that are not an integral number of octets.

dot3StatsFCSErrors—received frames that do not pass the FCS check.

dot3 StatsSingleCollisionFrames—Successfully transmitted frames that experience exactly one collision.

dot3StatsMultipleCollisionFrames—Successfully transmitted frames that experience more than one collision.

dot3StatsDeferredTransmission—Number of frames for which the first transmission attempt is delayed because medium is busy.

dot3 StatsLateCollision—Number of times a collision is detected later than 512-bit times into the transmission.

dot3StatsExcessiveCollisions—Frames for which transmission fails due to excessive collision.

dot3StatsInternalMacTransmitErrors—Frames for which transmission fails due to internal MAC.

dot3StatsCarrierSenseErrors—Number oftimes that the carrier sense condition was lost or never asserted when attempting to transmit a frame.

dot3StatsFrameTooLongs—received frames that exceeded maximum permitted frame size.

dot3StatsInternalMacReceiveErrors—Frames for which reception fails due to internal MAC transmit errors.

dot3CollFrequencies—Number of trans frames on a particular interface that experience exactly the number of collisions in the associated dot3CollCount object.

dot3ErrorLoopBackError—Expected data not received or not received correctly in loop-back test.

FCM fragments for the network 900 shown in FIG. 9 are illustrated in FIG. 14. FIG. 14 is one example of an FCM 1400 of the network 900 depicted in FIG. 9.

In this example, the following link partial orders are considered to illustrate the use of FCMs. The linked partial order PI as given below is illustrated in FIG. 10. It should be noted, however, that the listed linked partial orders are only by way of example and that they may assume other forms that are different from the ones listed.

P₁={greatly-decreases, decreases, no-change, increases, greatly-increases}

P₂={lack-of, likelihood}

P₃={good-prospect, no-discrimination, bad-prospect}

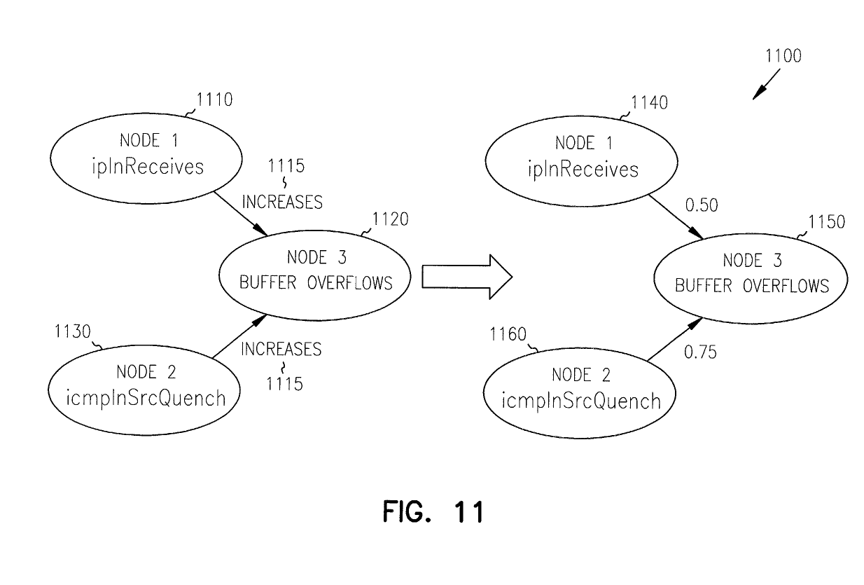

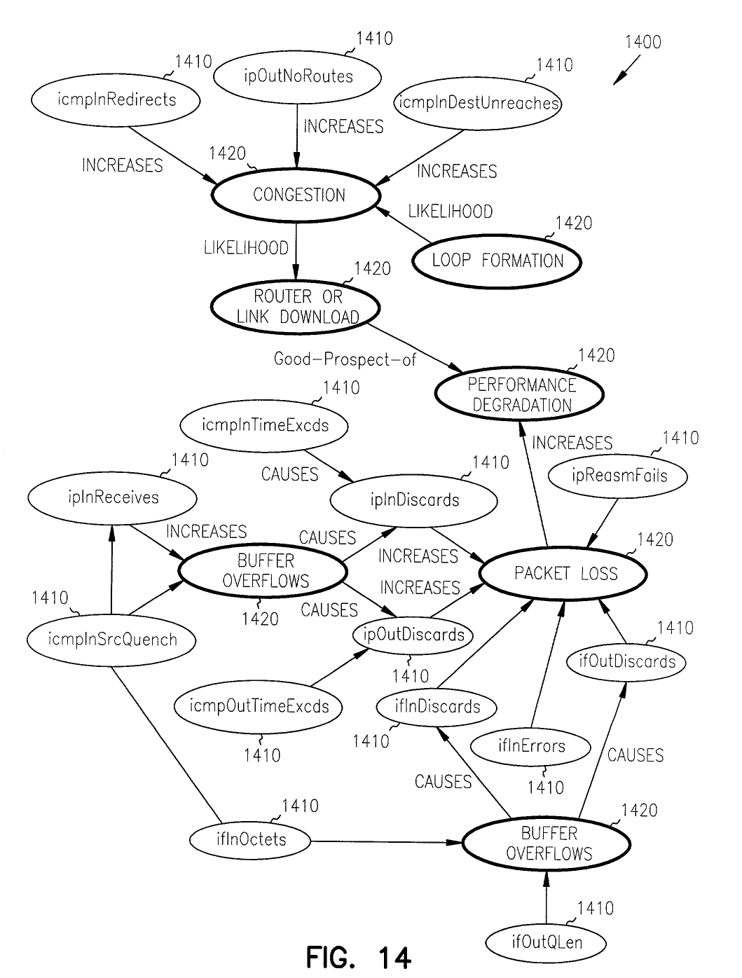

Creating FCM fragments involves finding relationships between concepts. The evidence available through studying network data or event logs or through an expert typically dictates the numerical values for a pair of concepts or objects. Referring to FIG. 13, the “Buffer overflow” node 1120 has two contexts 1110 and 1130 and “increases” 1115 in these two contexts 1110 and 1130 can have two different numerical values. The numerical values associated with the link partial order linguistic variables depend on the network context. For example, consider the fragment 100 shown in FIG. 11. The increase=μI₁₂<0.50 of FCM fragment 1100 of FIG. 11 was determined through a combination of expert opinion, network context and through trials where the effect of ipInReceives on Buffer flow was quantified to less than 0.50. FCM fragment increases=μI₂₃>0.75 was determined through expert opinion, network context and through trials where the effect of icmpInSrcQuench on Buffer flow was quantified to greater than 0.75.

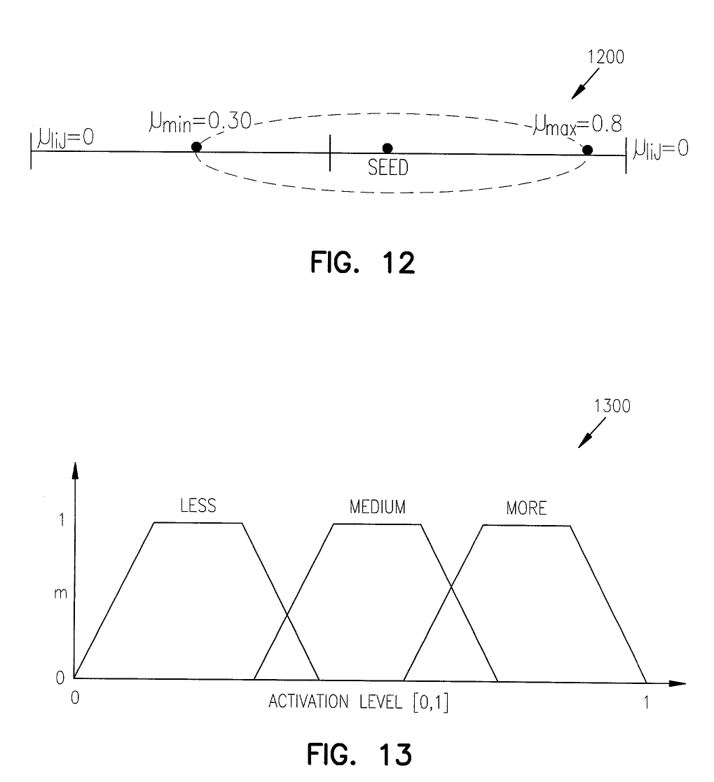

Across usage contexts, the numerical values for a linguistic quantifier can take can be defined by the spread of evidence values for positive and negative instances. Most of managed object nodes are counters that track the occurrence of an event and are fired when the counter hits a value. The spread of a linguistic variable depends on the counter values taken of the managed object node. FIG. 12 depicts the spread of “increases” 1200 as discovered in an experimentation.

In the given FCM fragment 1400, the shaded nodes are the concept nodes 1420 and the unshaded nodes 1410 are the network managed object nodes. The managed object nodes 1410 in the FCM fragment 1400 are counters whose values continue to increment. The count value from the managed objects, which arrives through a SNMP or a CMIP message, can be evaluated to establish the degree of evidence, as explained above. In FIG. 14, the tail nodes are nodes with text “icmpInRedirects”, “ipOutRoutes”, “icmpInDestUnreaches”, and the node with text “Performance degradation is a head node. The head concept nodes with text “Performance degradation” are critical nodes. Further evidence calculation can be required when there is ‘moderate’ evidence flow.

In the example, an activation level table of the concept nodes is maintained. Activation levels of the concept nodes reflect the amount of evidence flow into a concept node. The activation of a concept node at time ‘t’ can be described using the equation:

$${A}_{i}^{t + 1} = {f}_{M} ( {\sum }_{j = 1}^{n} {A}_{j}^{t} {W}_{ji} ) .$$

The non-linear function ƒ( ) is a sigmoid function with saturation levels 0 and 1. The activation level of each node can take values from the interval [0, 1 ]. A concept node is considered triggered if the evidence into that node is “more”. FIG. 13 illustrates the notion of “more” in graph 1300. This level of granularity of activation levels in deciding triggering of concept nodes gives a great degree of flexibility in fine-tuning the trigger mechanism in different network situations.

For activation or evidence levels falling in the gray region in FIG. 13, further evidence may be sought before a decision on the Trigger State of a node is considered. Seeking further evidence can involve querying the status of nodes that are immediately connected to the concept node in question but that have not contributed to the evidence. It might also involve waiting for the next sample of events whose inputs might prove useful in resolving the activation levels.

In the above example, predictions are presented as foreseen trends for the user to base actions on. The temporal order of the incoming and correlated events should be maintained. Temporal projections are done to maintain the temporal ordering of the correlated events and are achieved as mentioned previously.

The Network State can be seen as a constantly evolving state where faults and performance grades change constantly. Fault states and performance states keep changing due to user intervention and the correction logic generally built into the communication system. The above-described event-correlation describes event-correlation based on the activation of concept nodes in FCMs.

A decay factor can also be defined and used to capture the dynamic state of a concept node in a communication network. The decay factor can define the amount of current activation that will be lost at each step according to the decay mechanism. One equation that gives the amount of current activation loss at each step as per the decay mechanism is shown below:

Aᵢ^{t+1}=ƒ_{M}(Aᵢ^{t}, Sᵢ^{t})−dᵢAᵢ^{t}

Where Aᵢ^{t+1} is the new activation and Aᵢ^{t} is the activation level at time ‘t’, dᵢ is the decay factor of concept Cᵢ·Sᵢ^{t} describes the links (link matrix) between different nodes. The decay amount in each step requires an intimate knowledge of the network. An activation table containing the activation levels of concept nodes can be maintained and harvested at every step to check for triggering of concept nodes.

Once FCMs are drawn over a communication network and concept nodes are identified, they can be used as a decision support system where the goal is to maximize (Ex: performance) or minimize (Ex: faults) certain concept nodes. Statistics, such as, for example, the most often triggered concept node can be identified and the relevant causes can be fine-tuned to achieve better network performance.

Because fuzzy composition operators are used to compute evidence propagation, the system may be robust to a few missed events. Small changes in network configuration may lead to a change in the degree of dependency between nodes in the FCMs. The use of suitable well-known learning algorithms, like the one described in Bart Kosko, Fuzzy Engineering, Prentice Hall, 1997 can be used to determine the degree of dependency between nodes making the system adaptive.

To summarize, the above-described event-correlation process has two phases: (1) the modeling (composite event specification) phase which is achieved through the use of managed objects defined in a MIB and the use of expert knowledge; (2) the run-time composite event detection and inferring phase.

In the modeling phase, the network domains and contexts are specified and the network event dependencies are captured as FCMs. Concept nodes are defined to capture the abstract notions of a path of closely related events. Concept nodes summarize a normal path or a cycle. Both causal and temporal inconsistencies between events and concepts can be captured in the model. Typically, for centralized management systems, the inconsistencies are entered into centralized management system 800, such as, for example, the one depicted in FIG. 8. The inconsistencies are then be stored in the form of FCM event-correlation model(s) and the processor of the management system uses FCM event-correlation models and an incoming event stream, as depicted in FIG. 8, to achieve event-correlation.

In detecting the composite event at run-time the tail events and key vertices can be monitored from the stream of incoming notifications. This would typically be displayed on a monitor of the management system. In other embodiments, the management system may be configured to track specific events. This would be done by entering the specific events to be tracked into the management system. The events to be tracked would be stored in the storage of the management system, and the processing means would then search for the specific events. Those specific events would be displayed on, for example, a monitor of the management system.

The total or indirect effect on the connected concept nodes can be calculated with an additional check for the confidence in projection of effects over time. Further evidence gathering decisions can be taken in boundary cases and on critical nodes.

The embodiment depicted in FIG. 8 describes one system in which methods that incorporate aspects of the invention can be used to achieve event-correlation. In alternate embodiments, the event-correlation system can be distributed. In the distributed system, the event-correlation models can be stored in different network elements of a typical communication system as software agents. When the event-correlation system is stored in different network elements of a system, the FCM fragments can capture local contexts and can be monitored in a local context by local management systems. The event-correlation agents residing in different network elements can coordinate and communicate with the help of the central manager or through a communication protocol defining the mode of communication and coordination between the different agents. As discussed above, the distributed event-correlation system may also be stored on hardware chips or on software modules in each network element.

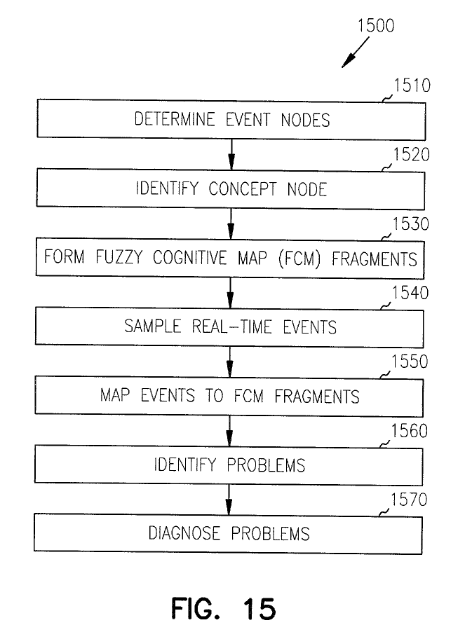

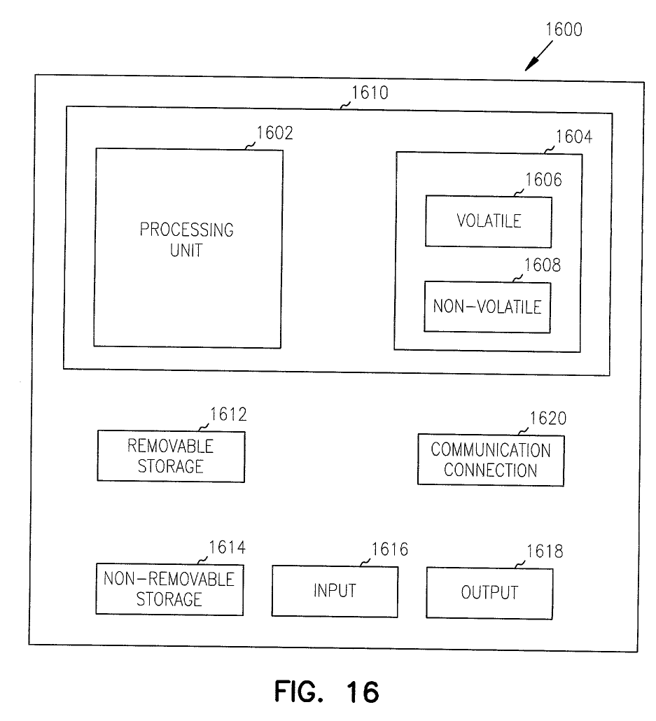

FIG. 15 is a flowchart illustrating one example embodiment of a process 1500 for diagnosing a problem from multiple events in a system of managed components generating real-time events of problems. The flowchart includes steps 1510-1570, which are arranged serially in the exemplary embodiment. However, other embodiments of the invention may execute two or more steps in parallel using multiple processors or a single processor organized as two or more virtual machines or subprocessors. Moreover, still other embodiments implement the steps as two or more specific interconnected hardware modules with related control and data signals communicated between and through the modules, or as portions of an application-specific integrated circuit. Thus, the exemplary process flow is applicable to software, firmware, and hardware implementations. The system can be an explicit system, an implicit system, a centralized system, a partially centralized system, and/or a distributed system. The system here means a communication network, including managed objects such as network objects, attached systems, and/or application objects.

The process begins with step 1510 by determining event nodes from events in the database. Events include exceptional conditions occurring in the operation of the network. Event nodes can include significant events selected from the group consisting of hardware/software failures, performance bottlenecks, configuration problems, and/or security violations. In some embodiments, the event nodes are determined using a database defining the network managed objects and event notifications that convey the state of one or more managed objects. In some embodiments, event nodes are determined from expert knowledge of the network. The database can include static and/or dynamic information. Static information can be associated with each class of managed objects, which are typically obtained from operation manuals of the attached systems. Dynamic information can include information that affects the causal propagation of events.

Step 1520 includes identifying concept nodes from the determined event nodes. In some embodiments, identifying concept nodes includes identifying a composite set of events that capture the notion of an abstract exception condition in the network. Abstract exception conditions can include conditions such as fault, and/or performance degradation. In some embodiments, capturing abstract exception condition includes capturing normal paths based on predetermined criteria on which the events have to be diagnosed. The predetermined criteria can include causal and temporal inconsistencies between events.

Step 1530 includes forming fuzzy cognitive maps (FCMs) including causally equivalent FCM fragments using network element interdependencies derived from a database defining the network managed objects and event notifications that convey the state of one or more managed objects. Formed FCM fragments can include interdependencies between the concept nodes using the determined event nodes and the identified concept nodes. In some embodiments, forming FCM fragments means capturing system event interdependencies. In some embodiments, the system interdependencies are captured by interconnecting event and concept nodes using interdependency arcs capturing temporal and logical dependencies. The interdependency arcs can comprise weights based on temporal and logical dependencies.

Step 1540 includes sampling generated incoming real-time events from the system. In some embodiments, sampling real-time events includes sampling the events sequentially in the order they are received from the network. Sampling of real-time events by the system is discussed in more detail with reference to FIG. 1.

Step 1550 includes mapping the sampled real-time events to the formed FCM fragments including determined event nodes to evaluate the effect of the mapped event nodes on the identified concept nodes using the determined interdependencies. In some embodiments, mapping the sampled real-time events to the formed FCM fragments includes correlating the received events to the determined concept nodes using the determined interdependencies. In some embodiments, correlating the received events comprises accumulating evidence based on the received event nodes and comparing the accumulated evidence to a threshold value. Then the concept nodes are analyzed based on the outcome of the comparing to evaluate the effect of the received event nodes. The process of evaluating the effect of the received event nodes on the concept nodes is discussed in more detail with reference to FIG. 1.

Step 1560 includes identifying problems by analyzing the concept nodes based on the outcome of the evaluation. In some embodiments, identifying problems include using the determined effect of the received event nodes on the concept nodes. Step 1570 includes diagnosing problems based on the outcome of the analysis.

Method 1500, shown in FIG. 15, may be implemented as a communication interface module 120, an event-processing module 130, an event-analyzer 140, a memory 160, and an interface output module 150 as shown in FIG. 1.

FIG. 16 shows an example of a suitable computing system environment 1600 for implementing embodiments of the present invention, such as those shown in FIGS. 1 and 15. Various aspects of the present invention are implemented in software, which may be run in the environment shown in FIG. 16 or any other suitable computing environment. The present invention is operable in a number of other general purpose or special purpose computing environments. Some computing environments are personal computers, server computers, hand-held devices, laptop devices, multiprocessors, microprocessors, set top boxes, programmable consumer electronics, network PCs, minicomputers, mainframe computers, distributed computing environments, and the like. The present invention may be implemented in part or in whole as computer-executable instructions, such as program modules that are executed by a computer. Generally, program modules include routines, programs, objects, components, data structures and the like to perform particular tasks or to implement particular abstract data types. In a distributed computing environment, program modules may be located in local or remote storage devices.

FIG. 16 shows a general computing device in the form of a computer 1610, which may include a processing unit 1602, memory 1604, removable storage 1612, and non-removable storage 1614. Memory 1604 may include volatile memory 1606 and non-volatile memory 1608. Computer 1610 may include—or have access to a computing environment that includes—a variety of computer-readable media, such as volatile memory 1606 and non-volatile memory 1608, removable storage 1612 and non-removable storage 1614. Computer storage includes RAM, ROM, EPROM & EEPROM, flash memory or other memory technologies, CD ROM, Digital Versatile Disks (DVD) or other optical disk storage, magnetic cassettes, magnetic tape, magnetic disk storage or other magnetic storage devices, or any other medium capable of storing computer-readable instructions. Computer 1610 may include or have access to a computing environment that includes input 1616, output 1618, and a communication connection 1620. The computer may operate in a networked environment using a communication connection to connect to one or more remote computers. The remote computer may include a personal computer, server, router, network PC, a peer device or other common network node, or the like. The communication connection may include a Local Area Network (LAN), a Wide Area Network (WAN) or other networks.

### Conclusion

The above-described invention provides an improved event-correlation system that better serves the needs specific to communication networks. The present invention accomplishes this by adapting to uncertainties and dynamic changes in the communication networks.

The above description is intended to be illustrative, and not restrictive. Many other embodiments will be apparent to those skilled in the art. The scope of the invention should therefore be determined by the appended claims, along with the full scope of equivalents to which such claims are entitled.

What is claimed is:

1. A method to diagnose a problem from multiple events in a system of managed components generating real-time events of problems, comprising:
forming fuzzy cognitive maps (FCMs) including causally equivalent FCM fragments using network element interdependencies derived from a database defining the network managed objects and event notifications that convey the state of one or more managed objects;
sampling generated incoming real-time events from the system; and
diagnosing problems by mapping the sampled events to the formed FCM fragments.

2. The method of claim 1, wherein forming the FCM fragments comprises:
determining event nodes from events in the database;
identifying concept nodes from the determined event nodes; and
forming FCM fragments including interdependencies between the concept and event nodes using the determined event nodes and the identified concept nodes.

3. The method of claim 2, wherein diagnosing the sampled events comprises:
mapping the sampled real-time events to the formed FCM fragments including determined event nodes to evaluate the effect of the mapped event nodes on the identified concept nodes using the determined interdependencies;
identifying the problems by analyzing the concept nodes based on the outcome of the evaluation; and
diagnosing the problems based on the outcome of the analysis.

4. The method of claim 3, wherein the system comprises:
a system selected from the group consisting of explicit system, implicit system, centralized system, partially centralized system, and distributed system.

5. The method of claim 3, wherein the events comprise:
exceptional conditions occurring in the operation of the network.

6. The method of claim 5, wherein the event nodes comprise:
significant events selected from the group consisting of hardware/software failures, performance bottlenecks, configuration problems, and security violations.

7. The method of claim 6, wherein determining the event nodes comprises:
determining the event nodes from a database defining the network managed objects and event notifications that convey the state of one or more managed objects.

8. The method of claim 7, wherein determining the event nodes further comprises:
determining the event nodes from expert knowledge of the network.

9. The method of claim 8, wherein the managed objects comprise:
objects selected from the group consisting of network objects, attached systems, and application objects.

10. The method of claim 8, wherein the database comprises:
static information associated with each class of managed and/or dynamic information that affects the causal propagation of events.

11. The method of claim 3, wherein sampling the incoming real-time events comprises:
sampling the incoming real-time events sequentially in the order they are received.

12. The method of claim 3, wherein identifying the concept nodes comprises:
identifying a composite set of events that capture the notion of an abstract exception condition in the network.

13. The method of claim 12, wherein the abstract exception condition comprises:
abstract exception conditions selected from the group consisting of a notion of fault and a notion of performance degradation, a network card in a communication system being faulty with the number of users being served by the communication system drastically reducing, and link between two routers going down leading to the use of alternate paths which lead to congestion and performance.

14. The method of claim 12, wherein capturing the abstract exception condition comprises:
capturing normal paths based on predetermined criteria on which the events have to be diagnosed.

15. The method of claim 14, wherein the criteria comprises:
causal and temporal inconsistencies between events.

16. The method of claim 1, wherein forming the FCM, comprises:
capturing system event interdependencies.

17. The method of claim 15, wherein capturing the system event interdependencies comprises:
interconnecting event and concept nodes using interdependency arcs capturing temporal and logical dependencies.

18. The method of claim 17, wherein the interdependency arcs comprise:
weights based on temporal and logical dependencies.

19. The method of claim 3, wherein evaluating the effect of the received event nodes on the concept nodes, comprises:
computing an indirect effect of events (predictive event-correlation) on concept nodes using the equations:
Iₚₓ(Eᵢ, Cᵢ)=min(eₚₓ(Eᵢ, Cⱼ)=min(eₚₓ_{ᵣ₁}(Eᵢ, Eₖ))⊕ . . . ⊕ min(eₚₓ_{ᵣₙ}(Eₖₙ, Cⱼ))
wherein the indirect effect of events Eᵢ on concept nodes Cᵢ can be defined as the intersection of the linked causal types and can be described by the above equation, eₚₓ is a function which takes Iᵢⱼ to [0, 1 ] in path ‘p’ i.e. e_{Iij}=f→(Iᵢⱼ, μᵢⱼ), μᵢⱼε{0, 1}, and ⊕ represents a concatenation of paths, wherein the concatenation operator ⊕ is generally considered as a fuzzy ‘and’ operator, wherein the operator (t-norm) for intersection of two fuzzy sets other than ‘min’ can be used using a ‘bounded difference,’ wherein the bounded difference can be computed using the equation:
t₁(μ_{A}(x), μ_{B}(x))=max{0, μ_{A}(x)+μ_{B}(x)−1}
wherein t₁( ) is a t-norm between fuzzy sets A and B with membership functions μ_{A} and μ_{B}.

20. The method of claim 19, wherein mapping the received real-time events to the formed FCM fragments comprises:
correlating the received events to the identified concept nodes to evaluate the effect of the received event nodes on the identified concept nodes using the determined element interdependencies.

21. The method of claim 20, wherein correlating the received events to the concept nodes further comprises:
accumulating evidence based on the received event nodes;
comparing the accumulated evidence to a threshold value; and
analyzing the concept nodes based on the outcome of the comparing to evaluate the effect of the received event nodes.

22. A method for diagnosing problems from multiple events in a communication network including managed components generating real-time events of problems, comprising:
forming fuzzy cognitive maps (FCMs) including causally equivalent FCM fragments using network element interdependencies;
sampling generated incoming real-time events from the network; and
diagnosing each of the generated problems by mapping the received sampled events to the formed FCM fragments.

23. The method of claim 22, wherein forming the FCM fragments comprises:
determining event nodes from events in the database;
identifying concept nodes from the determined event nodes; and
forming FCM fragments including interdependencies between the concept and event nodes using the determined event nodes and the identified concept nodes.

24. The method of claim 23, wherein diagnosing the sampled events comprises:
mapping the sampled real-time events to the formed FCM fragments including determined event nodes to evaluate the effect of the mapped event nodes on the identified concept nodes using the determined interdependencies;
identifying the problems by analyzing the concept nodes based on the outcome of the evaluation; and
diagnosing the problems based on the outcome of the analysis.

25. A computer readable medium having computer-executable instructions to diagnose problems from multiple events in a system of managed components generating real-time events of problems, comprising:
forming fuzzy cognitive maps (FCMs) including causally equivalent FCM fragments using network element interdependencies derived from a database defining the network managed objects and event notifications that convey the state of one or more managed objects;
sampling generated incoming real-time events from the system; and
diagnosing problems by mapping the sampled events to the formed FCM fragments.

26. The computer readable medium of claim 25, wherein forming the FCM fragments comprises:
determining event nodes from events in the database;
identifying concept nodes from the determined event nodes; and
forming FCM fragments including interdependencies between the concept and event nodes using the determined event nodes and the identified concept nodes.

27. The computer readable medium of claim 26, wherein diagnosing the sampled events comprises:
mapping the sampled real-time events to the formed FCM fragments including determined event nodes evaluate the effect of the mapped event nodes on the identified concept nodes using the determined interdependencies;
identifying the problems by analyzing the concept nodes based on activation levels of the concept nodes; and
diagnosing the problems based on the outcome of the analysis.

28. The computer readable medium of claim 27, wherein the system comprises:
a system selected from the group consisting of explicit system, implicit system, centralized system, partially centralized system, and distributed system.

29. The computer readable medium of claim 28, wherein the events comprise:
exceptional conditions occurring in the operation of the network.

30. The computer readable medium of claim 29, wherein the event nodes comprise:
significant events selected from the group consisting of hardware/software failures, performance bottlenecks, configuration problems, and security violations.

31. The computer readable medium of claim 27, wherein identifying the concept nodes comprises:
identifying a composite set of events that capture the notion of an abstract exception condition in the network.

32. The computer readable medium of claim 27, wherein evaluating the effect of the received event nodes on the concept nodes, comprises:
computing an indirect effect of events on concept nodes using the equations:
Iₚₓ(Eᵢ, Cᵢ)=min(eₚₓ(Eᵢ, Cⱼ))=min(eₚₓ_{ᵣ₁}(Eᵢ, Eₖ))⊕ . . . ⊕ min(eₚₓ_{ᵣₙ}(Eₖₙ, Cⱼ))
wherein the indirect effect of events Eᵢ on concept nodes Cᵢ can be defined as the intersection of the linked causal types and can be described by the above equation, eₚₓ is a function which takes Iᵢⱼ to [0, 1] in path ‘p’ i.e. e_{Iij}=f→(Iᵢⱼ, μᵢⱼ), μᵢⱼε{0, 1}, and ⊕ represents a concatenation of paths, wherein the concatenation operator ⊕ is generally considered as a fuzzy ‘and’ operator, wherein the operator (t-norm) for intersection of two fuzzy sets other than ‘min’ can be used using a ‘bounded difference,’ wherein the bounded difference can be computed using the equation:
t₁(μ_{A}(x), μ_{B}(x))=max{0, μ_{A}(x)+μ_{B}(x)−1}
wherein t₁( ) is a t-norm between fuzzy sets A and B with membership functions μ_{A} and μ_{B}.

33. A computer system to diagnose problems from multiple events in a system of managed components generating real-time events of problems, comprising:
a storage device;
an output device; and
a processor programmed to repeatedly perform a method, comprising:
forming fuzzy cognitive maps (FCMs) including causally equivalent FCM fragments using network element interdependencies derived from a database defining the network managed objects and event notifications that convey the state of one or more managed objects;
sampling generated incoming real-time events from the system; and
diagnosing problems by mapping the sampled events to the formed FCM fragments.

34. The system of claim 33, wherein forming the FCM fragments comprises:
determining event nodes from events in the database;
identifying concept nodes from the determined event nodes; and
forming FCM fragments including interdependencies between the concept and event nodes using the determined event nodes and the identified concept nodes.

35. The system of claim 34, wherein diagnosing the sampled events comprises:
mapping the sampled real-time events to the formed FCM fragments including determined event nodes evaluate the effect of the mapped event nodes on the identified concept nodes using the determined interdependencies;
identifying the problems by analyzing the concept nodes based on the outcome of the evaluation; and
diagnosing the problems based on the outcome of the analysis.

36. The system of claim 35, wherein the events comprise:
exceptional conditions occurring in the operation of the network.

37. The system of claim 35, wherein the event nodes comprise:
significant events selected from the group consisting of hardware/software failures, performance bottlenecks, configuration problems, and security violations.

38. The system of claim 35, wherein identifying the concept nodes comprises:
identifying a composite set of events that capture the notion of an abstract exception condition in the network.

39. The system of claim 35, wherein forming the FCM, comprises:
capturing system event interdependencies by interconnecting event and concept nodes using interdependency arcs that capture temporal and logical dependencies.

40. The system of claim 35, wherein evaluating the effect of the received event nodes on the concept nodes, comprises:
computing an indirect effect of events on concept nodes using the equations:
Iₚₓ(Eᵢ, Cᵢ)=min(eₚₓ(Eᵢ, Cⱼ))=min(eₚₓ_{ᵣ₁}(Eᵢ, Eₖ))⊕ . . . ⊕ min(eₚₓ_{ᵣₙ}(Eₖₙ, Cⱼ))
wherein the indirect effect of events Eᵢ on concept nodes Cᵢ can be defined as the intersection of the link causal types and can be described by the above equation, eₚₓ is a function which takes Iᵢⱼ to [0, 1] in path ‘p’ i.e. e_{Iij}=f→(Iᵢⱼ, μᵢⱼ ), ε{0, 1 }, and ⊕ represents a concatenation of paths, wherein the concatenation operator ⊕ is generally considered as a fuzzy ‘and’ operator, wherein the operator (t-norm) for intersection of two fuzzy sets other than ‘min’ can be used using a ‘bounded difference,’ wherein the bounded difference can be computed using the equation:
t₁(μ_{A}(x), μ_{B}(x))=max({0, μ_{A}(x)+μ_{B}(x)−1}
wherein t₁( ) is a t-norm between fuzzy sets A and B with membership functions μ_{A} and μ_{B}.

41. An event-correlation system to diagnose problems from multiple incoming real-time events in a communication network of managed components generating real-time events of problems, comprising:
an event-analyzer to form fuzzy cognitive map (FCM) fragments using network element interdependencies derived from a database defining the network managed objects and event notifications that convey the state of one or more managed objects; and
an event-processing module coupled to the event-analyzer to sample generated incoming real-time events from the network, wherein the analyzer to diagnose the problems from the sampled events by mapping the sampled events to the formed FCM fragments.

42. The event-correlation system of claim 41, wherein the analyzer forms FCM fragments by determining event nodes from events in the database, and by further identifying concept nodes from the determined event nodes to form FCM fragments including interdependencies between the identified concept nodes and the determined event nodes.

43. The event-correlation system of claim 41, wherein the analyzer further maps the sampled events to the formed FCM fragments including determined event nodes to evaluate the effect of the mapped events on the determined concept nodes using the determined interdependencies, wherein the analyzer identifies the problems by analyzing the concept nodes based on the outcome of the evaluation and further diagnoses the problems based on the outcome of the analysis.

44. The event-correlation system of claim 43, wherein the communication network comprises:
a system selected from the group consisting of explicit system, implicit system, centralized system, partially centralized system, and distributed system.

45. The event-correlation system of claim 43, wherein the events comprise:
exceptional conditions occurring during operation of the network.

46. The event-correlation system of claim 45, wherein the event nodes comprise:
significant events selected from the group consisting of hardware/software failures, performance bottlenecks, configuration problems, and security violations.

47. The event-correlation system of claim 46, wherein the analyzer determines the event nodes from a database defining the network managed- objects and event notifications that convey the state of one or more managed objects.

48. The event-correlation system of claim 47, wherein the analyzer determines the event nodes from expert knowledge of the network.

49. The event-correlation system of claim 48, wherein the managed objects comprise:
objects selected from the group consisting of network objects, attached systems, and application objects.

50. The event-correlation system of claim 48, wherein the database comprises:
static information associated with each class of managed objects and/or dynamic information that affects the causal propagation of events.

51. The event-correlation system of claim 43, further comprising:
a communication interface module coupled between the network and the event-processing module to extract events from real-time messages received in different formats from the network and to further sample the extracted events sequentially in the order they are received.

52. The event-correlation system of claim 43, wherein the analyzer identifying the concept nodes comprises a composite set of events that capture a notion of an abstract exception condition in the network.

53. The event-correlation system of claim 52, wherein the abstract exception condition comprises conditions selected from the group consisting of a notion of fault and a notion of performance degradation.

54. The event-correlation system of claim 52, wherein the analyzer captures the abstract exception condition by capturing normal paths based on predetermined criteria from which for the events are diagnosed.

55. The event-correlation system of claim 54, wherein the criteria comprises:
causal and temporal inconsistencies between events.

56. The event-correlation system of claim 43, wherein the analyzer forms FCM by capturing system event interdependencies.

57. The event-correlation system of claim 56, wherein the analyzer captures system interdependencies by interconnecting event and concept nodes using interdependency arcs to capture temporal and logical dependencies.

58. The event-correlation system of 57, wherein the interdependency arcs comprise:
weights based on temporal and logical dependencies.

59. The event-correlation system of claim 43, wherein the analyzer evaluates an indirect effect of events on concept nodes using the equations:
Iₚₓ(Eᵢ, Cᵢ)=min(eₚₓ(Eᵢ, Cⱼ))=min(eₚₓ_{ᵣ₁}(Eᵢ, Eₖ))⊕ . . . ⊕ min(eₚₓ_{ᵣₙ}(Eₖₙ, Cⱼ))
wherein the indirect effect of events Eᵢ on concept nodes Cᵢ can be defined as the intersection of the link causal types and can be described by the above equation, eₚₓ is a function which takes Iᵢⱼ to [0, 1 ] in path ‘p’ i.e. e_{Iij}=f→(Iᵢⱼ, μᵢⱼ), μᵢⱼε{0, 1}, and ⊕ represents a concatenation of paths, wherein the concatenation operator ⊕ is generally considered as a fuzzy ‘and’ operator, wherein the operator (t-norm) for intersection of two fuzzy sets other than ‘min’ can be used using a ‘bounded difference,’ wherein the bounded difference can be computed using the equation:
t₁(μ_{A}(x), μ_{B}(x))=max{0, μ_{A}(x)+μ_{B}(x)−1}
wherein t₁( ) is a t-norm between fuzzy sets A and B with membership fimctions μ_{A} and μ_{B}.

60. The event-correlation system of claim 59, wherein the analyzer maps the received real-time events to the formed FCM fragments by correlating the received events to the identified concept nodes to evaluate the effect of the received event nodes on the identified concept nodes using the determined element interdependencies.

61. The event-correlation system of claim 59, wherein the analyzer correlates the received events by accumulating evidence based on the received event nodes and compares the accumulated evidence to a threshold value, and analyzes the concept nodes based on the outcome of the comparing to evaluate the effect of the received event nodes.

62. The event-correlation system of claim 43, further comprising:
an interface output module coupled to the event-analyzer to output one or more solutions based on the outcome of diagnosing the problems by the analyzer.

63. The event-correlation system of claim 62, further comprising:
a memory to store the static and dynamic information.
